(19) United States
(12) Patent Application Publication
(10) Pub. No.: US 2006/0004645 A1
(43) Pub. Date: Jan. 5, 2006

(54) Reversed auction

(76) Inventor: Christer Andersson, Balinge (SE)

Correspondence Address: NIXON & VANDERHYE, PC, 901 NORTH GLEBE ROAD, 11TH FLOOR, ARLINGTON, VA, 22203, US

(21) Appl. No.: 10/880,613

(22) Filed: Jul. 1, 2004

(51) Int. Cl. G06F 17/60

(52) U.S. Cl. 705/37

(57) ABSTRACT

The invention relates to a system, a home page and a method in an open network for at least one of data- or telecommunication providing an electronic market place comprising a reversed auction application. Hereby a customer auctions out a product or a service to be purchased by the customer, and participating vendors or merchants of said auction offer there unique price for selling the product.

### TECHNICAL FIELD

The present invention pertains to a system, a home page and a method in an open network for at least one of data- or telecommunication. It provides an electronic market place comprising a reversed auction application, through which a customer auctions out a product or a service to be purchased by the customer herself, whereby vendors or merchants participating in the auction offer there unique price for selling the product or services.

### BACKGROUND ART

Currently small hardware stores, small electronic equipment retailers and other vendors or merchants have a big disadvantage in doing business. There market is often limited to faithful and/or professional craftsmen's as customers.

The average customer is likely to visit a mall, supermarket or other like places to purchase for instance electronic equipment such as power tools or any other product. This pattern of customer behavior makes it very difficult for the small business to compete as the supermarket stocks for instance hundreds of power drills, and the small business stocks five pieces as an example. This means that the small business has a higher purchase price for its articles, and of course a higher of the shell price. Perhaps even worse, people are very aware of this condition, so they do not even bother to visit small retailing stores, although they may get a much quicker and better service at these retailers.

Furthermore, the Internet trading is very conventional. Customers surf from one Internet portal or page to find the product that suits them the best, much like going from shop to shop in order to by an item, but much faster by using data- and/or telecommunication equipment and networks.

The present invention aims to solve some of the problems involved with the disadvantage of competition between small retailers and big enterprises such as supermarkets, malls and the like. Moreover, a big advantage with the present invention is for the consumer/customer who will get a fair price for a product or services without having to actively search by herself on for instance the Internet.

### SUMMARY OF THE INVENTION

An aim of the present invention is to reverse the procedure of auctioning items for purchase. Hence, the present invention relates to a system in an open network for at least one of data- or telecommunication providing an electronic market place comprising a reversed auction application, through which a customer auctions out a product or a service to be purchased by the customer herself, and where participating vendors or merchants of the auction offer there unique most favorable bid for selling the product. The invention further comprises:

a central server auction facility connected to the network, providing a registration regarding a service or product reversed auctioned by the customer;

a code computing means delivering a unique auction product code to the customer after registering;

a means providing a serial No. for the auction;

a timer for counting the time of closing the auction;

a means in the application informing vendors and merchants providing the auctioned product or services of the auction;

a bidding means where vendors or merchant bid on the auctioned services or product, whereby the most favorable bid is registered;

the timer closing the auction when reaching the closing time, whereby the customer is informed of the most preferable bid;

a means for accepting or rejecting the bid by the customer, if accepted a payment is accomplished to a neutral account and the purchasing customer is informed about the vendor or merchant and the merchant or vendor is informed about the payment and the unique customer code; and

the sale being completed and the vendor or merchant being provided payment from the neutral account, whereby the introduction of the code to the customer and the serial No. to the merchant or vendors, thus the purchaser and merchant being unaware of there identity until receiving the product code from the application in order to close a fair deal.

In one embodiment of the present invention the application is scanning the network for the best possible offer made for the product or services auctioned, making up the starting bid for merchants or vendors.

Another embodiment comprises that the registered bid is displayed on an application portal or homepage in the www or the like.

Furthermore, the present invention sets forth a home page in an open network for at least one of data- or telecommunication providing an electronic market place illustrating a reversed auction application, through which a customer auctions out a product or a service to be purchased by the customer, and where participating vendors or merchants of the auction offer there unique most favorable bid for selling the product. The home page thus comprises:

providing a registration regarding a service or product reversed auctioned by the customer;

a code computing means displaying a unique auction product code to the customer after registering;

a means providing a serial No. for the auction;

a timer for counting the time of closing the auction;

a bidding means where vendors or merchant bid on the auctioned services or product, whereby the most favorable bid is registered;

the timer closing the auction when reaching the closing time, whereby the customer is informed of the most preferable bid; and

a means for accepting or rejecting the bid by the customer.

In one embodiment of the home page the application is scanning the network for the best possible offer made for the product or services auctioned, making up the starting bid on the home page for merchants or vendors.

Another embodiment comprises that the registered bid is displayed through the www by the homepage.

Moreover, the present invention sets forth a method in an open network for at least one of data- or telecommunication providing an electronic market place comprising a reversed auction application, through which a customer auctions out a product or a service to be purchased by the customer, and where participating vendors or merchants of the auction offer there unique most favorable bid for selling the product. The method comprises the steps of:

providing a registration regarding a service or product reversed auctioned by the customer at a central server auction facility connected to the network;

delivering a unique auction product code to the customer after registering;

providing a serial No. for the auction;

counting the time of closing the auction through a timer;

informing vendors and merchants providing the auctioned product or services of the auction;

vendors or merchants bidding on the auctioned services or product, whereby the most favorable bid is registered;

closing the auction when reaching the closing time through the timer, whereby the customer is informed of the most preferable bid;

the customer accepting or rejecting the bid, if accepted a payment is accomplished to a neutral account and the purchasing customer is informed about the vendor or merchant and the merchant or vendor is informed about the payment and the unique customer code; and

completing the sale, and the vendor or merchant being provided payment from the neutral account, whereby the introduction of the code to the customer and the serial No. to the merchant or vendors, thus the purchaser and merchant being unaware of there identity until receiving the product code from the application in order to close a fair deal.

One embodiment of the method of the present invention comprises that the application is scanning the network for the best possible offer made for the product or services auctioned, making up the starting bid for merchants or vendors.

Another embodiment comprises that the registered bid is displayed on an application portal or homepage in the www.

### BRIEF DESCRIPTION OF THE DRAWING

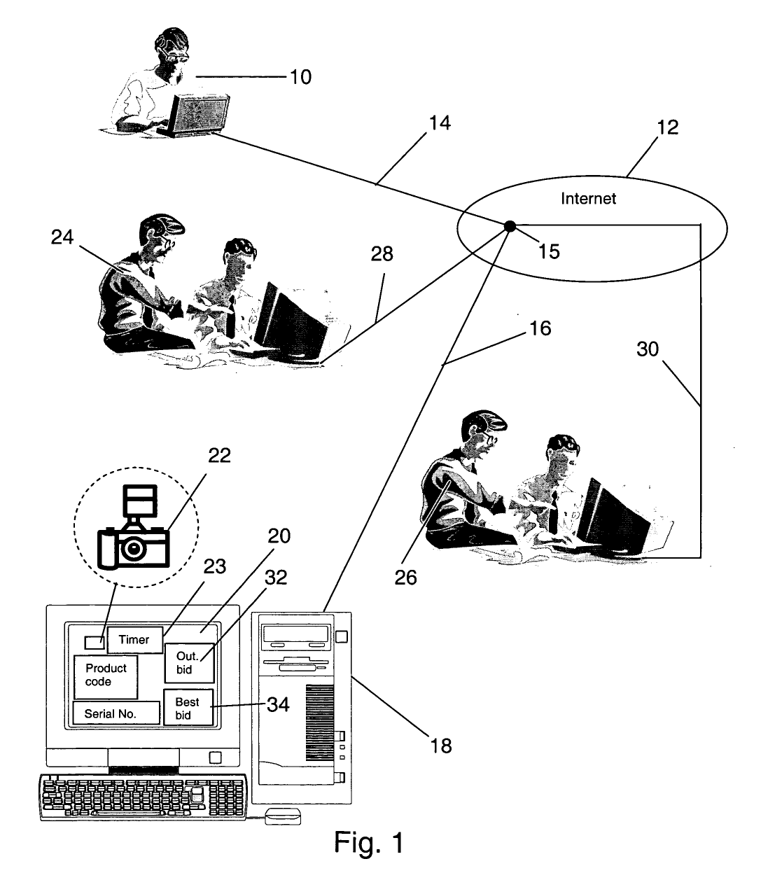

Henceforth, the present invention is described with reference to its single drawing for a better understanding of its advantages through its given examples and embodiments, whereby the single FIG. 1 schematically illustrates a system for auctioning products and/or services in accordance with the present invention.

### DETAILED DESCRIPTION OF PREFERRED EMBODIMENTS OF THE INVENTION

The web based market place in accordance with the present invention reverses the current purchase pattern between customer manufacturer/merchant/vendors. Hence the customer/buyer is so to speak “auctioned” out to interested merchants/vendors attached to Internet. As should be understood, the product that a customer would like to buy is auctioned out. This selling procedure is accomplished through a specific application for that purpose. The reversed auction accomplishes that the bidder's merchants and vendors most probably are lowering their bids, contrary to conventional auctions where customers bid, and raise their bids to purchase an item or a services.

In order to let customers without computer equipment be able to utilize the present invention, conventional techniques such as telephony, fax, SMS and the like are possible to utilize for the purpose of upholding a communication with a central server auction facility/site, where a customers auctioned products or services can be manually input in the portal or home page application that handles the auction of the present invention.

Now, with reference to the single FIG. 1, a costumer 10 that would like to buy an article/product or services visits a central server site/node 15 for instance by the Internet 12 through a connection 14, wire or wireless. At the node 15 at least one server 18 is situated, having at least one computer display 20 for serving the server application and to set up auctions in which merchants/vendors/manufactures of products/articles or service companies 22, 26 such as, for example, power tool retailers or services like travel agencies, booking agencies, or leasing business are able to bid on the product or services a customer 10 would like to purchase or order. The form on the display 20 is distributed through a home page one the Internet 12 that could be accessed by any person.

In the embodiment or example given in the present invention, the customer 10 would like to buy a digital camera 22 of a specific brand on his/hers terms possibly to an acceptable price, and perhaps with other favorable offers related to the purchase. Hence the reverse auctioning is taken place, by the vendors/merchants 24, 26 bidding as low and favorable price or bidding as possible for the customer 10 in accordance with their margins in relation to the purchase price. The favorable bidding could for instance include other offers such as future discounts and/or gifts.

As can be seen in FIG. 1, the customer puts in his/hers preferences in the homepage belonging to the application of the present invention for the camera 22 via line 14 to node 15 and 16 connecting the central auctioning server 18 in accordance with the present invention. Firstly the customer 10 enters the type of camera 22 to be purchased in the form presented on the display 20 name, address, telephone number, shipping data, e-mail, time for the auction to be open or when to close, and other preferences.

The application provides a product code to the customer for that single auction. This code is only provided the customer 10, and thus not distributed to other persons visiting the home page. Moreover, the application sets a timing function through, for example, a timer/counter/clock 23, which determines how long the customer 10 accepts a bargaining or auction bidding for the camera 22 in this example, i.e., time for the auction to be open. Thus, the timer increments or decrements the auction open time, for example, remaining auction time 24 hours, 59 minutes and 06 seconds, in a known manner for the person skilled in the art of timers. Furthermore, the auction is assigned a serial No. to be utilized by the possible merchants, customer and others to be able to see how the auction progresses.

Now, the application for auctioning searches the www or the like network with a search motor for the best price or price with offers, when such a price is found it is entered in the homepage on display 20 as for instance lowest price 32 on Internet 12. This lowest price acts as a starting bid in one embodiment of the present invention for the merchants/vendors which are obliged (trusted) to bid according to this specific auction. In another embodiment the auction could be started without the presentation of a lowest Internet price or price from another like network.

The application now contacts merchants/vendors providing the specific product, in this case cameras, via e-mail, SMS (Short Message Service), MMS (Multimedia Messaging Service), GPRS (General Packet Radio Service) or the like that and auction is taking place. Thereafter, interested merchants visit via lines 28, 30 and 16 to the application portal and/or homepage to fill in the form shown on the display 20 containing their biddings. The most preferable bidding will be displayed on the homepage for the product with the specific serial No. regarding the camera 22.

As an example, an interested merchant/vendor could in order to be trusted fill out a form on the home page like the following:
Company:
Address:
Contact:
Telephone No.:
Would you like reminders of future business:
e-mail:
SMS
Other means:

A probable course of action now taking place in the biding phase of the present invention, would be that merchants/vendors offer lower or similar prices/bids 34 compared to the starting or outgoing bid 32 found by the application engine.

One possible scenario for the reverse auction in accordance with the present invention would be that the market evolves to a local market in a geographical sense of view, i.e., a customer would get bids from merchants or vendors in a range not so far from where he/she lives. In this manner for instance a country/state would soon be covered of island like areas with local reversed auction markets in accordance with the present invention. This does not mean that no global auctions are possible, as Internet and like networks are global in their structure.

When the timer has lapsed its counting, the customer is informed by the application about the most preferable bidding and asked if the bid is accepted or not. If accepted, a payment is transferred to a neutral account at a bank or the like financial institution, when this has appeared, the customer is informed about the merchant, and the merchant is informed that the business or auction is closed and being provided the code for the business of for instance the purchase of a product reverse auctioned, herein as an example of a product, the camera 22. Hence the merchant receives the payment for the auctioned product minus a possible fee for the bargain.

In accordance with the present invention, thus a system in an open network, such as the Internet 12 and the www, for at least one of data- or telecommunication providing an electronic market place is accomplished. The electronic market place comprises a reversed auction application according to the present invention, through which a customer auctions 10 out a product 22 or a service to be purchased by the customer 10.

The vendors or merchants 24, 26 participating in the auction offer there unique price for selling the product. A system in accordance with the present invention thus comprises:

a central server auction facility 18 connected to the network 12, providing a registration regarding a service or product 22 reversed auctioned by the customer 10;

a code computing means delivering a unique auction code to the customer after registering;

means providing a serial No. to the auction;

a timer 23 for counting the time to the closing of the auction;

at least one display screen 20 connected to the network;

a means in the application informing vendors and merchants providing the auctioned product or services of the auction;

a bidding means where vendors or merchant bid on the auctioned services or product, whereby the most favorable bid is displayed on the display;

the timer closing the auction when reaching the closing time and the customer is informed of the bid;

a means for accepting or rejecting the bid by the customer, if accepted a payment is accomplished to a, for the customer and the vendor or merchant, neutral account and the purchasing customer is informed about the vendor or merchant and the merchant or vendor is informed about the payment and the unique customer code; and

the sale being completed and the vendor or merchant being provided payment from the neutral account.

In one embodiment of the present invention the application is scanning the network 12 for the best possible offer made for the product or services auctioned. Also, a display of the best offer 34 on the display screen home page being the starting bid in the auction.

By introducing the code to the customer and the serial No. to the merchants, both purchaser and merchant are unaware of there identity for the closing of a fair deal until they accept the deal.

Moreover, the present invention sets forth a home page display 20 in an open network 12 for at least one of data- or telecommunication providing an electronic market place illustrating a reversed auction application. A customer 10 auctions out a product 22 or a service to be purchased through the home page. The participating vendors or merchants 24, 26 of the auction offer there unique most favorable bid 34 for selling the product. The home page thus comprises:

providing a registration regarding a service or product reversed auctioned by the customer;

a code computing means displaying a unique auction product code to the customer after registering;

a means providing a serial No. for the auction;

a timer 23 for counting the time of closing the auction;

a bidding means where vendors or merchant bid on the auctioned services or product 22, whereby the most favorable bid 34 is registered;

the timer 23 closing the auction when reaching the closing time, whereby the customer 24, 26 is informed of the most preferable bid; and

a means for accepting or rejecting the bid by the customer.

In one embodiment of the home page the application is scanning the network 12 for the best possible offer made for the product or services auctioned, making up the starting bid 32 on the home page for merchants or vendors.

The present invention also sets forth a method in an open network 12 for at least one of data- or telecommunication providing an electronic market place. It thus comprises a reversed auction application, through which a customer 10 auctions out a product 22 or a service to be purchased by the customer 10. The participating vendors or merchants 24, 26 of the auction offer there unique most favorable bid 34 for selling the product 22. The method comprises the steps of:

providing a registration regarding a service or product reversed auctioned by the customer at a central server auction facility 18 connected to the network;

delivering a unique auction product code to the customer after registering;

providing a serial No. for the auction;

counting the time of closing the auction through a timer 23;

informing vendors and merchants 24, 26 providing the auctioned product or services of the auction;

vendors or merchants 24, 26 bidding on the auctioned services or product, whereby the most favorable bid is registered;

closing the auction when reaching the closing time through the timer 23, whereby the customer is informed of the most preferable bid;

the customer 10 accepting or rejecting the bid, if accepted a payment is accomplished to a neutral account and the purchasing customer is informed about the vendor or merchant and the merchant or vendor 24, 26 is informed about the payment and the unique customer code;

completing the sale, and the vendor or merchant being provided payment from the neutral account, whereby the introduction of the code to the customer and the serial No. to the merchant or vendors, thus the purchaser and merchant being unaware of there identity until receiving the product code from the application in order to close a fair deal.

Although, the present invention has been described through examples and preferred embodiments, the attached set of claims is not limited to those, but to what is expected of a person skilled in the art.

1. A system in an open network for at least one of data- or telecommunication providing an electronic market place comprising a reversed auction application, through which a customer auctions out a product or a service to be purchased by said customer, and where participating vendors or merchants of said auction offer there unique most favorable bid for selling said product, comprising:
a central server auction facility connected to said network, providing a registration regarding a service or product reversed auctioned by said customer;
a code computing means delivering a unique auction product code to said customer after registering;
a means providing a serial No. for said auction;
a timer for counting the time of closing the auction;
a means in said application informing vendors and merchants providing the auctioned product or services of the auction;
a bidding means where vendors or merchant bid on said auctioned services or product, whereby the most favorable bid is registered;
said timer closing said auction when reaching the closing time, whereby the customer is informed of the most preferable bid;
a means for accepting or rejecting the bid by the customer, if accepted a payment is accomplished to a neutral account and the purchasing customer is informed about the vendor or merchant and the merchant or vendor is informed about the payment and said unique customer code; and
said sale being completed and said vendor or merchant being provided payment from said neutral account, whereby the introduction of said code to the customer and said serial No. to the merchant or vendors, thus the purchaser and merchant being unaware of there identity until receiving the product code from the application in order to close a fair deal.

2. A system according to claim 1, wherein said application is scanning the network for the best possible offer made for the product or services auctioned, making up the starting bid for merchants or vendors.

3. A system according to claim 1, wherein said registered bid is displayed on an application portal or homepage in the www.

4. A home page in an open network for at least one of data- or telecommunication providing an electronic market place illustrating a reversed auction application, through which a customer auctions out a product or a service to be purchased by said customer, and where participating vendors or merchants of said auction offer there unique most favorable bid for selling said product, comprising:
providing a registration regarding a service or product reversed auctioned by said customer;
a code computing means displaying a unique auction product code to said customer after registering;
a means providing a serial No. for said auction;
a timer for counting the time of closing the auction;
a bidding means where vendors or merchant bid on said auctioned services or product, whereby the most favorable bid is registered;
said timer closing said auction when reaching the closing time, whereby the customer is informed of the most preferable bid; and
a means for accepting or rejecting the bid by the customer.

5. A system according to claim 4, wherein said application is scanning the network for the best possible offer made for the product or services auctioned, making up the starting bid on said home page for merchants or vendors.

6. A system according to claim 4, wherein said registered bid is displayed through the www by said homepage.

7. A method in an open network for at least one of data- or telecommunication providing an electronic market place comprising a reversed auction application, through which a customer auctions out a product or a service to be purchased by said customer, and where participating vendors or merchants of said auction offer there unique most favorable bid for selling said product, comprising the steps of:
providing a registration regarding a service or product reversed auctioned by said customer at a central server auction facility connected to said network;
delivering a unique auction product code to said customer after registering;
providing a serial No. for said auction;
counting the time of closing the auction through a timer;
informing vendors and merchants providing the auctioned product or services of the auction;
vendors or merchants bidding on said auctioned services or product, whereby the most favorable bid is registered;
closing said auction when reaching the closing time through said timer, whereby the customer is informed of the most preferable bid;
the customer 10 accepting or rejecting the bid, if accepted a payment is accomplished to a neutral account and the purchasing customer is informed about the vendor or merchant and the merchant or vendor is informed about the payment and said unique customer code; and
completing said sale, and said vendor or merchant being provided payment from said neutral account, whereby the introduction of said code to the customer and said serial No. to the merchant or vendors, thus the purchaser and merchant being unaware of there identity until receiving the product code from the application in order to close a fair deal.

8. A method according to claim 7, wherein said application is scanning the network for the best possible offer made for the product or services auctioned, making up the starting bid for merchants or vendors.

9. A method according to claim 7, wherein said registered bid is displayed on an application portal or homepage in the www.
